(19) United States
(12) Patent Application Publication
(10) Pub. No.: US 2026/0253763 A1
(43) Pub. Date: Aug. 27, 2026

(54) CABLE

(71) Applicant: BOREALIS AG, Vienna (AT)

(72) Inventors: Johan ANDERSSON, Stenungsund (SE); Villgot ENGLUND, Stenungsund (SE); Daniel NILSSON, Stenungsund (SE); Annika SMEDBERG, Stenungsund (SE); Emy SILFVERBERG, Stenungsund (SE); Virginie ERIKSSON, Stenungsund (SE); Ramona HUUVA, Stenungsund (SE); Niklas THORN, Stenungsund (SE)

(21) Appl. No.: 18/874,848

(22) PCT Filed: Jun. 16, 2022
(86) PCT No.: PCT/EP2022/066497

§ 371 Date: Dec. 13, 2024

(51) Int. Cl. H01B 7/17

(52) U.S. Cl. CPC H01B 7/17

(57) ABSTRACT

A cable comprising a conductor which is surrounded by at least an inner semi conductive layer, an insulation layer and an outer semi conductive layer in that order; wherein said inner and/or outer semi conductive layer comprises an LDPE homopolymer or LDPE copolymer, an antioxidant, carbon black and a peroxide selected from the group consisting of a saturated aliphatic monofunctional peroxide and a saturated aliphatic bifunctional peroxide and a monofunctional peroxide containing an aromatic group; and wherein said insulation layer comprises an LDPE homopolymer or LDPE copolymer and a peroxide selected from the group consisting of an aliphatic monofunctional peroxide, an aliphatic bifunctional peroxide and a monofunctional peroxide containing an aromatic group.

The invention relates to a cable such as a crosslinked power cable in which the electrical DC conductivity of the insulation layer is reduced through the careful design of the surrounding semiconductive layers.

### BACKGROUND

A standard power cable comprises a conductor surrounded by an inner semiconductive shield (also called the conductor shield), insulation layer and outer semiconductive shield (also called the insulation shield) in that order. The cable may also be provided with additional layers, such as for instance jacketing, as is well known in the art.

The electrical DC conductivity here after denominated as DC conductivity of such a cable should be low and controlled in order to mitigate thermal runaway of the cable system when used at a range of operating temperatures and electrical stresses and especially at high temperatures and electrical stresses.

The present inventors have found that increases in the DC conductivity of the insulation layer in such a cable can relate to the composition of the semiconductive layers which are in contact with the insulation material.

It will be appreciated that layers within a power cable are often crosslinked. The crosslinking reaction is usually initiated using a peroxide. It is known that decomposition products of the peroxide used in the insulation layer may impair the DC conductivity. The peroxide is typically incorporated to the material layers prior to, or during, the extrusion of the layer(s) on a conductor. After formation of the layered cable, it is subjected to elevated temperature where radical formation is initiated thereby achieving crosslinking.

The peroxide decomposition products of peroxides in the insulation and semiconductive layers may include decomposition products that have a negative influence on the electrical properties of the cable and/or volatile decomposition products. Therefore the decomposition products are conventionally reduced or removed after crosslinking. Such removal step is generally known as a degassing step.

DC conductivity is an important material property e.g. for insulating materials for high voltage direct current (HV DC) cables. First of all, the temperature and electric field dependence of this property will influence the resulting electric field within the cable. The second issue is the fact that heat will be generated inside the insulation by the electric leakage current flowing between the inner and outer semiconductive layers. This leakage current depends on the electric field and the DC conductivity of the insulation. High DC conductivity of the insulating material can even lead to thermal runaway under high stress/high temperature conditions. The DC conductivity must therefore be sufficiently low to avoid thermal runaway during operation.

There are high demands to increase the voltage of a power cable to achieve an increased power transmission. There is still a continuous need to find alternative polymer compositions that leads to a reduced DC conductivity in the cable. Such polymer compositions should suitably also have good mechanical properties required for demanding power cable embodiments.

The peroxide decomposition products of certain peroxides in the semiconductive layer can influence the DC conductivity in the insulation layer. It appears that these decomposition products might migrate from the semiconductive layer into the insulation layer which is detrimental to performance. Careful selection therefore of the peroxide used in the semi-conductive shields is important. The present inventors have therefore designed a cable with particular components within the insulation and semiconductive layers which minimise the DC conductivity in the insulation layer by ensuring that the semiconductive layers comprise only certain peroxides.

### SUMMARY OF INVENTION

Viewed from one aspect the invention provides a cable comprising a conductor which is surrounded by at least an inner semiconductive layer, an insulation layer and an outer semiconductive layer in that order;
wherein said inner and/or outer semiconductive layer comprises an LDPE (low density polyethylene) homopolymer or LDPE copolymer, an antioxidant, carbon black and a peroxide selected from the group consisting of a saturated aliphatic monofunctional peroxide and a saturated aliphatic bifunctional peroxide; and
wherein said insulation layer comprises an LDPE homopolymer or LDPE copolymer and a peroxide selected from the group consisting of an aliphatic monofunctional peroxide, an aliphatic bifunctional peroxide and a monofunctional peroxide containing an aromatic group.

Viewed from one aspect the invention provides a cable comprising a conductor which is surrounded by at least an inner semiconductive layer, an insulation layer and an outer semiconductive layer in that order;
wherein said inner and outer semiconductive layers independently comprise an LDPE homopolymer or LDPE copolymer, an antioxidant, carbon black and a peroxide selected from the group consisting of a saturated aliphatic monofunctional peroxide and a saturated aliphatic bifunctional peroxide;
wherein said insulation layer comprises an LDPE homopolymer or LDPE copolymer and a peroxide selected from the group consisting of an aliphatic monofunctional peroxide, an aliphatic bifunctional peroxide and a monofunctional peroxide containing an aromatic group.

The cable of the invention is crosslinkable.

Viewed from another aspect the invention provides a crosslinked cable obtainable by the crosslinking of the cable as hereinbefore defined.

Viewed from another aspect the invention provides a crosslinked power cable obtainable by the crosslinking of the cable as hereinbefore defined.

Viewed from another aspect the invention provides a process for producing a cable comprising a conductor surrounded by at least an inner semiconductive layer, an insulation layer, and an outer semiconductive layer in that order, wherein the process comprises the steps of
extruding, such as coextruding, on a conductor an inner semiconductive layer, an insulation layer and outer semiconductive layer; and
crosslinking one or more of said inner semiconductive layer, insulation layer and outer semiconductive layer;
wherein said inner and outer semiconductive layer independently comprises an LDPE homopolymer or LDPE copolymer, an antioxidant, carbon black and a peroxide selected from the group consisting of a saturated aliphatic monofunctional peroxide and a saturated aliphatic bifunctional peroxide;
wherein said insulation layer comprises an LDPE homopolymer or LDPE copolymer and a peroxide selected from the group consisting of an aliphatic monofunctional peroxide, an aliphatic bifunctional peroxide and a monofunctional peroxide containing an aromatic group.

### DETAILED DESCRIPTION OF THE INVENTION

The present invention provides a cable comprising a conductor which is surrounded by at least an inner semiconductive layer, an insulation layer and an outer semiconductive layer. The invention also relates to a crosslinked cable comprising a conductor which is surrounded by at least an inner semiconductive layer, an insulation layer and an outer semiconductive layer.

### Inner and Outer Semiconductive Layers

The inner and outer semiconductive layers can be the same or different, preferably the same. By the same here means that the chemical composition of the inner and outer semiconductives layers is identical, prior to crosslinking. Both layers may comprise one or several LDPE homopolymer(s) or LDPE copolymer(s), an antioxidant, carbon black and a peroxide selected from a saturated aliphatic monofunctional peroxide, or a saturated aliphatic bifunctional peroxide. The discussion which follows can apply to either or both of the semiconductive layers.

It is also possible to use the combination of a polyethylene plastomer and a low density polyethylene (LDPE) homopolymer or LDPE copolymer.

### Low Density Polyethylene (LDPE) Homopolymer or LDPE Copolymer

Although the term LDPE is an abbreviation for low density polyethylene, the term is understood not to limit the density range, but covers the LDPE-like high pressure (HP) polyethylenes. The term LDPE describes and distinguishes only the nature of HP polyethylene with typical features, such as different branching architecture, compared to the polyethylene produced in the presence of an olefin polymerisation catalyst. The term LDPE means herein a low density homopolymer of ethylene (referred herein as LDPE homopolymer) or a low density copolymer of ethylene with one or more comonomer(s) (referred herein as LDPE copolymer).

The LDPE of use in the inner and/or outer semiconductive layer can be an LDPE homopolymer but it is preferably an LDPE copolymer with one or more comonomers. It is also possible to employ a mixture of low density polyethylene (LDPE) homopolymer or LDPE copolymers in the inner and/or outer semiconductive layer.

It is preferred if the LDPE copolymer of use in the inner and/or outer semiconductive layer comprises one or more polar comonomers. As a polar comonomer for the LDPE copolymer, a comonomer(s) containing a carboxyl and/or ester group(s) is used. Still more preferably, the polar comonomer(s) of LDPE copolymer is selected from the group of acrylate(s), methacrylate(s) or acetate(s), or any mixtures thereof.

If present in said LDPE copolymer, the polar comonomer(s) is preferably selected from the group of alkyl acrylates, alkyl methacrylates or vinyl acetate, or a mixture thereof. Further preferably, said polar comonomer(s) is selected from C₁- to C₆-alkyl acrylates, C₁- to C₆-alkyl methacrylates or vinyl acetate. Still more preferably, the LDPE copolymer used in the inner and/or outer semiconductive layer is a copolymer of ethylene with C₁- to C₄-alkyl acrylate, such as methyl, ethyl, propyl or butyl acrylate, or vinyl acetate.

The use of ethylene methyl acrylate (EMA) copolymer, ethylene methyl methacrylate (EMMA) copolymer, ethylene ethyl acrylate (EEA) copolymer, ethylene ethyl methacrylate (EEMA), ethylene butyl methacrylate (EBMA), ethylene butyl acrylate (EBA) copolymer or ethylene vinyl acetate (EVA) copolymer is preferred.

The use of ethylene methyl acrylate (EMA), ethylene butyl acrylate (EBA) or ethylene ethyl acrylate (EEA) is especially preferred.

If the LDPE is a copolymer, it preferably comprises 0.001 to 40 wt-%, more preferably 0.05 to 40 wt-%, more preferably 0.05 to 30 wt-%, still more preferably 1 to 30 wt-%, of one or more comonomer(s). Where there is a polar comonomer, the polar comonomer content is preferably 5 to 30 wt-%, 7 to 30 wt %, 10 to 30 wt % 5 to 25 wt-%, 5 to 20 wt-% such as 7 to 20 wt-%. In some embodiments there may be 10 to 20 wt % or 12 to 25 wt % comonomer(s) present.

Preferably, the LDPE homopolymer or LDPE copolymer has a melt flow rate MFR₂ of 0.1 to 50 g/10 min, more preferably 1.0 to 30 g/10 min, even more preferably 2.0 to 25 g/10 min, and most preferably 5.0 to 22 g/10 min. Alternatively, the LDPE homopolymer or LDPE copolymer has a melt flow rate MFR₂ of 10 to 22 g/10 min.

Any LDPE homopolymer or LDPE copolymer may have a density of 910 to 940 kg/m³, preferably 915 to 935 kg/m³, such as 915 to 930 kg/m³.

The LDPE homopolymer or LDPE copolymer can be produced by any conventional polymerisation process. Preferably, it is produced by radical polymerisation, such as high pressure radical polymerisation. High pressure polymerisation can be effected in a tubular reactor or an autoclave reactor. Preferably, it is a tubular reactor. In general, the pressure can be within the range of 1200-3500 bars and the temperature can be within the range of 100° C.-350° C. Further details about high pressure radical polymerisation are given in Encyclopedia of Polymer Science and Engineering, Vol. 6 (1986), pp 383-410 and Encyclopedia of Materials: Science and Technology, Elsevier Science Ltd.: “Polyethylene: High-pressure, R. Klimesch, D. Littmann and F.-O. Mähling pp. 7181-7184.2001, which is herewith incorporated by reference.

It is well known that e.g. propylene can be used as a comonomer or as a chain transfer agent (CTA), or both, whereby it can contribute to the total amount of the C—C double bonds, preferably to the total amount of the vinyl groups. Herein, when a compound which can also act as comonomer, such as propylene, is used as CTA for providing double bonds, then said copolymerisable comonomer is not calculated to the comonomer content.

The inner and/or outer semiconductive layer may comprise at least 50 wt-% of the LDPE homopolymer or LDPE copolymer, such as at least 60 wt-%. Where a blend of LDPE homopolymer or LDPE copolymers is used then this percentage refers to the sum of the LDPE homopolymer or LDPE copolymers present.

In some embodiments, there is at least 65 wt-% of the LDPE homopolymer or LDPE copolymer. The LDPE generally forms the balance of the layer once other components of the semiconductive layer are selected.

### Insulation Layer

The cable of the invention comprises an insulation layer comprising a LDPE homopolymer or LDPE copolymer and a peroxide selected from aliphatic monofunctional peroxide, aliphatic bifunctional peroxide or monofunctional peroxide containing an aromatic group. The insulation layer may comprise a mixture of LDPE homopolymer or LDPE copolymers.

The LDPE is preferably an LDPE homopolymer or an LDPE copolymer with at least one polyunsaturated comonomer. In one embodiment, the LDPE of the insulation layer comprises fewer than 5 wt-% polar comonomers such less than 5 wt-% comonomer comprising carboxyl groups or ester groups such as acrylate or acetate monomers. In one embodiment, the LDPE homopolymer or LDPE copolymer of the insulation layer comprises fewer than 3.0 wt-%, preferably less than 2.0 wt-%, especially less than 1.0 wt-% polar comonomers such less than 3.0 wt-%, preferably less than 2.0 wt-%, especially less than 1.0 wt-% comonomer comprising carboxyl groups or ester groups such as acrylate or acetate monomers.

If the LDPE homopolymer or LDPE copolymer is a copolymer, it preferably comprises at least one polyunsaturated comonomer and optionally with one or more other comonomer(s). Preferably, the LDPE copolymer is a binary copolymer of ethylene and one polyunsaturated comonomer only.

The polyunsaturated comonomer preferably consists of a straight carbon chain with at least 8 carbon atoms and at least 4 carbons between the non-conjugated double bonds, of which at least one is terminal. The polyunsaturated comonomer is preferably a diene, e.g., a diene which comprises at least eight carbon atoms, the first carbon-carbon double bond being terminal and the second carbon-carbon double bond being non-conjugated to the first one, e.g., a diene which is selected from C₈- to C₁₄-non-conjugated diene or mixtures thereof, for example, selected from 1,7-octadiene, 1,9-decadiene, 1,11-dodecadiene, 1,13-tetradecadiene, 7-methyl-1,6-octadiene, 9-methyl-1,8-decadiene, or mixtures thereof, e.g., from 1,7-octadiene, 1,9-decadiene, 1,11-dodecadiene, 1,13-tetradecadiene, or any mixture thereof.

If the LDPE is an LDPE copolymer, it preferably comprises 0.001 to 40 wt-%, preferably 0.05 to 40 wt-%, more preferably 0.05 to 30 wt-%, still more preferably 1.0 to 30 wt-%, still more preferably 1.0 to 20 wt-% of one or more comonomer(s). Where there is a polyunsaturated comonomer, the polyunsaturated comonomer content is preferably 0.001 to 10 wt-%, preferably 0.01 to 10 wt-%, more preferably 0.01 to 5.0 wt-%, still more preferably 0.01 to 3.0 wt-%, especially 0.01 to 2.0 wt-%, more especially 0.1 to 2.0 wt-%. In some embodiments, the only comonomer present is a polyunsaturated comonomer.

Preferably, the LDPE homopolymer or LDPE copolymer has a melt flow rate MFR₂ of 0.1 to 50 g/10 min, preferably 0.3 to 20 g/10 min, more preferably 0.3 to 15 g/10 min, even more preferably 0.50 to 15 g/10 min, or 0.50 to 10 g/10 min. In some embodiments the MFR₂ is 0.50 to 8.0 g/10 min, preferably 0.50 to 6.0 g/10 min, most preferably 0.50 to 4.0 g/10 min.

Any LDPE homopolymer or LDPE copolymer may have a density of 905 to 935 kg/m³, such as 910 to 928 kg/m³, preferably 915 to 925 kg/m³.

The insulation layer is preferably free of carbon black. It may comprise at least 80 wt-% of the LDPE homopolymer or LDPE copolymer, such as at least 90 wt-%. In some embodiments, there is at least 95 wt-% of the LDPE homopolymer or LDPE copolymer. Where a blend of LDPE homopolymer or LDPE copolymers is used then this percentage refers to the sum of the LDPE homopolymer or LDPE copolymers present.

The LDPE homopolymer or LDPE copolymer generally forms the balance of the layer once other components are calculated. The insulation layer preferably contains no more than 99.95 wt-% of the LDPE homopolymer or LDPE copolymer.

### Carbon Black

According to the present invention, the inner and outer semiconductive layers further comprise carbon black.

The semiconductive properties result from the carbon black added. Thus, the amount of carbon black is at least such that a semiconducting layer is obtained. Preferably, the inner and/or outer semiconductive layer comprises 10 to 48 wt-% carbon black. In other preferred embodiments, the amount of carbon black is 10 to 45 wt-%, 15 to 45 wt-%, 20 to 45 wt-%, 25 to 45 wt-%, 25 to 40 wt-%, or 25 to 35 wt-%, based on the weight of the semiconductive layer.

Examples of suitable carbon blacks include acetylene blacks.

Acetylene carbon blacks can be produced in an acetylene black process by thermal decomposition of acetylene gas by reaction of acetylene and unsaturated hydrocarbons, e.g. as described in U.S. Pat. No. 4,340,577.

Acetylene blacks may have a mean primary particle size of larger than 20 nm, e.g. 20 to 80 nm. The mean primary particle size is defined as the number average particle diameter according to the ASTM D3849-95a. Suitable acetylene blacks of this category have an iodine adsorption number between 30 to 300 mg/g, e.g. 30 to 150 mg/g according to ASTM D1510. Further, the oil absorption number (of this category) is, for example between 80 to 300 ml/100 g, e.g. 100 to 280 ml/100 g, and this is measured according to ASTM D2414. Acetylene black is a generally acknowledged term and are very well known and e.g. supplied by Denka.

Mixtures may also be used. Where a blend of carbon blacks is used then this percentage refers to the sum of the carbon blacks present.

### Peroxide—Semiconductive Layers

The peroxide is preferably added to the inner and/or outer semiconductive layer in an amount of less than 3.0 wt-%, more preferably 0.1 to 2.5 wt-%, even more preferably 0.3 to 2.5 wt-% based on the weight of the semiconductive layer. In some embodiments the peroxide is present in 0.5 to 2.5 wt-% based on the weight of the semiconductive layer. In one embodiment there is 0.5 to 2.0 wt-% peroxide based on the weight of the semiconductive layer. Where a blend of peroxides is used then this percentage refers to the sum the peroxides present.

The peroxide is a saturated aliphatic monofunctional peroxide or a saturated aliphatic bifunctional peroxide. Mixtures of peroxides may be used. The term “monofunctional” is used herein to define a peroxide in which there is a single O—O group. The term “bifunctional” describes a peroxide is which there are two O—O groups.

As the peroxide is aliphatic, the peroxide should not comprise an aromatic group such as a phenyl ring. Also the peroxide should not contain three or more O—O groups. Peroxides such as 1,4-bis[2-(tert-butylperoxy)propan-2-yl]benzene or 1,3-bis[2-(tert-butylperoxy)propan-2-yl]benzene are therefore excluded.

The term “saturated” is used herein to define a peroxide which does not comprise a carbon-carbon double or triple bond.

In one embodiment, it is preferred if the inner and outer semiconductive layers of the cable of the invention are free of a peroxide which contains an aromatic group such as a phenyl ring. In one embodiment, it is preferred if the inner and outer semiconductive layers of the cable of the invention are free of a peroxide which contains three or more O—O groups. In one embodiment, it is preferred if the inner and outer semiconductive layers of the cable of the invention are free of a peroxide which contains a carbon-carbon double or triple bond such as a hexene or hexyne group. Ideally, it is preferred if the inner and outer semiconductive layers of the cable of the invention are free of all such peroxides.

The peroxide may be added to the semiconductive composition used to form the semiconductive layer during the compounding step (i.e. when the polyolefin is mixed with the carbon black), or after the compounding step in a separate process, or when the semiconductive composition is extruded.

It is preferred if the peroxide is a liquid at a temperature of 20 to 45° C., preferably 25 to 40° C. (atmospheric pressure).

As peroxides used for crosslinking, the following can be mentioned: di-tert-amylperoxide, 2,5-di(tert-butylperoxy)-2,5-dimethylhexane, di(tert-butyl)peroxide, and butyl-4,4-bis(tert-butylperoxy)valerate.

Preferably, the peroxide is selected from 2,5-di(tert-butylperoxy)-2,5-dimethylhexane, di(tert-butyl)peroxide, or mixtures thereof. Most preferably, the peroxide is 2,5-di(tert-butylperoxy)-2,5-dimethyl-hexane.

### Peroxide—Insulation Layer

As peroxides used for crosslinking the insulation layer, the following compounds can be mentioned: di-tert-amylperoxide, 2,5-di(tert-butylperoxy)-2,5-dimethyl-3-hexyne, 2,5-di(tert-butylperoxy)-2,5-dimethylhexane, tert-butylcumylperoxide, di(tert-butyl)peroxide, dicumylperoxide, butyl-4,4-bis(tert-butylperoxy)valerate, tert-butylperoxybenzoate, dibenzoylperoxide.

Preferably, the peroxide is selected from 2,5-di(tert-butylperoxy)-2,5-dimethylhexane, dicumylperoxide, tert-butylcumylperoxide, di(tert-butyl)peroxide, or mixtures thereof. Most preferably, the peroxide is tert-butylcumylperoxide, dicumylperoxide or 2,5-di(tert-butylperoxy)-2,5-dimethyl-hexane.

It is preferred if dicumyl peroxide or 2,5-di(tert-butylperoxy)-2,5-dimethyl-hexane is used in the insulation layer.

The peroxide is preferably added to the insulation layer in an amount of less than 3.0 wt-%, more preferably 0.1 to 2.5 wt-%, even more preferably 0.3 to 2.5 wt-%. 0.4 to 2.0 wt-% 0.4 to 1.5 wt-%, 0.4 to 1.0 wt-%, based on the weight of the insulation layer. Where a blend of peroxides is used then this percentage refers to the sum the peroxides present.

### Antioxidant

Any layer of the cable core can comprise an antioxidant. As antioxidant, sterically hindered or semi-hindered phenols, aromatic amines, aliphatic sterically hindered amines, organic phosphates, thio compounds, polymerized 2,2,4-trimethyl-1,2-dihydroquinoline and mixtures thereof, can be mentioned.

More preferred, the antioxidant is selected from the group of 4,4′-bis(1,1′dimethylbenzyl)diphenylamine, para-oriented styrenated diphenylamines, 4,4′-thiobis (2-tert-butyl-5-methylphenol), polymerized 2,2,4-trimethyl-1,2-dihydroquinoline, or derivatives thereof.

More preferred, the antioxidant is selected from the group (but not limited to) of 4,4′-bis(1,1′dimethylbenzyl)diphenylamine, para-oriented styrenated diphenylamines, 4,4′-thiobis (2-tert.butyl-5-methylphenol), 2,2′-thiobis(6-t-butyl-4-methylphenol), distearylthiodipropionate, 2,2′-thio-diethyl-bis-(3-(3,5-di-tertbutyl-4-hydroxyphenyl)propionate, polymerized 2,2,4-trimethyl-1,2-dihydroquinoline, or derivatives thereof. Of course, not only one of the above-described antioxidants may be used but also any mixture thereof.

The amount of antioxidant, optionally a mixture of two or more antioxidants, can range from 0.005 to 2.5 wt-%, such as 0.01 to 2.5 wt-%, preferably 0.01 to 2.0 wt-%, more preferably 0.03 to 2.0 wt-%, especially 0.03 to 1.5 wt-%, more especially 0.05 to 1.5 wt-%, or 0.1 to 1.5 wt-% based on the weight of the semiconductive layer.

The insulation layer may also comprise an antioxidant, e.g. as defined for the semiconductive layer. The antioxidant used in the insulation is preferably different from that used in the inner and/or outer semiconductive layer. The amount of antioxidant, optionally a mixture of two or more antioxidants, can range from 0.005 to 2.5 wt-%, preferably 0.01 to 2.5 wt-%, more preferably 0.01 to 2.0 wt-%, especially 0.03 to 2.0 wt-%, more especially 0.03 to 1.5 wt-% based on the weight of the insulation layer. In some embodiments the amount of antioxidant is 0.04 to 1.5 wt-%, preferably 0.04 to 1.0 wt-%, more preferably 0.04 to 0.8 wt-%, especially 0.04 to 0.6 wt-%, more especially 0.04 to 0.5 wt-% based on the weight of the insulation layer.

### Other Components

The inner and/or outer semiconductive layer or the insulation layer may comprise further additives. As possible additives, scorch retarders, crosslinking boosters, stabilisers, processing aids, flame retardant additives, acid scavengers, inorganic fillers, voltage stabilizers, or mixtures thereof can be mentioned.

A “scorch retarder” is defined to be a compound that reduces premature crosslinking i.e. the formation of scorch during extrusion. Besides scorch retarding properties, the scorch retarder may simultaneously result in further effects like boosting, i.e. enhancing crosslinking performance. The use of a scorch retarder in the insulation layer is especially preferred.

Useful scorch retarders can be selected from unsaturated dimers of aromatic alpha-methyl alkenyl monomers, substituted or unsubstituted diphenylethylene, quinone derivatives, hydroquinone derivatives such as 2,5-ditert-butyl hydroquinone, monofunctional vinyl containing esters and ethers, or mixtures thereof. More preferably, the scorch retarder is selected from unsaturated dimers of aromatic alpha-methyl alkenyl monomers, such as 2,4-diphenyl-4-methyl-1-pentene, substituted or unsubstituted diphenylethylene, or mixtures thereof. A highly preferred option is 2,4-diphenyl-4-methyl-1-pentene.

Preferably, the amount of scorch retarder is within the range of 0.005 to 1.0 wt %, more preferably within the range of 0.01 to 0.80 wt %, based on the weight of the layer in question. Further preferred ranges are 0.03 to 0.75 wt-%, 0.05 to 0.70 wt-% and 0.050 to 0.50 wt-%, based on the total weight of the layer in question.

In a further embodiment of the present invention, no scorch retarder is used in the manufacture of the inner and/or outer semiconductive layers.

In a further embodiment of the present invention, no scorch retarder is used in the manufacture of the insulation layer.

The crosslinking booster may be a compound containing at least 2, unsaturated groups, such as an aliphatic or aromatic compound, an ester, an ether, an amine, or a ketone, which contains at least 2, unsaturated group(s), such as a cyanurate, an isocyanurate, a phosphate, an ortho formate, an aliphatic or aromatic ether, or an allyl ester of benzene tricarboxylic acid. Examples of esters, ethers, amines and ketones are compounds selected from general groups of diacrylates, triacrylates, tetraacrylates, triallylcyanurate, triallylisocyanurate, 3,9-divinyl-2,4,8,10-tetra-oxaspiro[5,5]-undecane (DVS), triallyl trimellitate (TATM) or N,N,N′,N′,N″,N″-hexaallyl-1,3,5-triazine-2,4,6-triamine (HATATA), or any mixtures thereof. The crosslinking booster can be added in an amount of such crosslinking less than 2.0 wt %, for example, less than 1.5 wt %, e.g. less than 1.0 wt %, for example, less than 0.75 wt %, e.g. less than 0.5 wt %, and the lower limit thereof is, for example, at least 0.05 wt %, e.g., at least 0.1 wt %, based on the total weight of the layer in question.

In a further embodiment of the present invention, no crosslinking booster is used in the manufacture of the inner and/or outer semiconductive layers.

In a further embodiment of the present invention, no crosslinking booster is used in the manufacture of the insulation layer.

### Conductor

The cable of the invention comprises a conductor. The conductor can be made from any suitable conductive metal, typically copper or aluminium.

### Cable

A power cable is defined to be a cable transferring energy operating at any voltage, typically operating at voltages higher than 1 kV. The voltage applied to the power cable can be alternating (AC), direct (DC), or transient (impulse).

The term “cable” as used herein, is intended to denote a cable comprising at least one cable core, optionally two cable cores or three cable cores. Each “cable core” as used herein, comprises a conductor surrounded by at least an inner semiconductive layer, an insulation layer and an outer semiconductive layer. The one or more cable cores in the cable may be surrounded by at least one reinforcing layer and/or an armouring layer adapted for mechanical protection of the cable. The armouring layer may comprise metallic wires, braid, sheath or low loss armour. These variations and cable constructions are familiar to the person skilled in the art. The armouring layer may extend across parts of the cable.

The term “DC cable” refers to a direct current (DC) cable generally comprising one or more cable cores, preferably one or two cable cores.

The cable according to the present invention is very advantageously a DC power cable, which can be e.g. a low voltage (LV), a medium voltage (MV), a high voltage (HV) or an extra high voltage (EHV) or an ultra-high voltage (UHV) DC cable, which terms, as well known, indicate the level of operating voltage. The DC power cable may operate at voltages of at least 30 kV, such as a HVDC cable. For HVDC cables the operating voltage is defined herein as the electric voltage between ground and the conductor of the high voltage cable.

The cable may be an HVDC power cable operating at voltages of 40 kV or higher, even at voltages of 50 kV or higher even 60 kV or higher. In some embodiments, the operating voltage may be higher than 80 kV. The upper limit is not limited. A practical upper limit can be up to 1100 kV. The HVDC power cables operating from 80 to 320 kV, or those operating at 320 to 525 kV or 320 to 640 kV are most preferred.

As well known the cable can optionally comprise further layers, e.g. layers surrounding the outer semiconductive layers, such as screen(s), a jacketing layer, other protective layer(s) or any combinations thereof.

A cable can be produced by the process comprising the steps of (a)
providing and mixing, for example, melt mixing in an extruder, a crosslinkable first semiconductive composition for the inner semiconductive layer,
providing and mixing, for example, melt mixing in an extruder, a crosslinkable insulation composition for the insulation layer,
providing and mixing, for example, melt mixing in an extruder, a second semiconductive composition for the outer semiconductive layer,

(b) applying on a conductor, for example, by co-extrusion,
a melt mix of the first semiconductive composition obtained from step (a) to form the inner semiconductive layer,
a melt mix of insulation layer composition obtained from step (a) to form the insulation layer, and
a melt mix of the second semiconductive composition obtained from step (a) to form the outer semiconductive layer, and

(c) optionally crosslinking at crosslinking conditions one or more of the insulation layer, the inner semiconductive layer and the outer semiconductive layer, of the obtained cable.

It is preferred that if a peroxide is used in the manufacture of a layer of the cable then such a layer is crosslinked. The cable of claim 1 is therefore crosslinkable and defines a cable before crosslinking.

The first semiconductive composition for the inner semiconductive layer, crosslinkable insulation composition for the insulation layer, and the second semiconductive composition for the outer semiconductive layer comprise the components necessary to form the respective inner, insulation and outer layers of the cable.

During preparation of the polymer compositions, the components can be blended, e.g. melt mixed in compounding equipment. Preferably, said process does not involve the use of peroxide. Typically, the process involves heating to a temperature of at least 150° C., preferably at least 160° C., such as at least 170° C. The process will generally involve heating to 300° C. or less, such as 250° C. or less.

It is understood that all definitions and preferences, as described above, equally apply for all further embodiments, as described below. In one embodiment the insulation layer composition of the present invention may comprise a crosslinking agent before said composition is used for cable production, whereby the polymer components and the crosslinking agent can be blended by any conventional mixing process, e.g. by addition of the crosslinking agent to a melt of a composition of polymer, e.g. in an extruder, as well as by adsorption of liquid peroxide, peroxide in liquid form or peroxide dissolved in a solvent on a solid composition of polymer, e.g. pellets thereof. The obtained insulation layer composition of components, for example, among others the polymer components, the antioxidant(s) and the crosslinking agent, is then used for an article, e.g. a cable core, preparation process.

In another embodiment, the crosslinking agent may be added e.g. in a step during the preparation of the crosslinkable article, and also forms the insulation layer composition as used in the cable core of the present invention. When the crosslinking agent is added during the article preparation process, then, for example, the crosslinking agent, as described herein, is added in a liquid form at ambient temperature, or is preheated above the melting point thereof or dissolved in a carrier medium, as well known in the art.

The insulation layer composition as used in the cable core of the present invention may also comprise further additive(s), or further additive(s) may be blended to the polymer composition during a preparation process of an article comprising the insulation layer composition. It is understood that the further additive(s), including any antioxidant, crosslinking agent, scorch retarder, may be added in the form of a masterbatch, as well known in the art.

In a particular embodiment, the semiconductive layers as used in the cable core of the present invention may be obtained by several means using several different production technologies such as, for example, internal mixers such as Banbury or Bolling, continuous single screws such as BUSS, or continuous twin screws such as Farrel or Werner & Pfleiderer. The type of mixer and the chosen operating conditions for the preparation of the semiconductive compound will have a direct impact on the melt quality and will affect final compound properties, such as melt flow rate, volume resistivity and surface smoothness. Of particular usefulness is the co-kneader technology (BUSS, X-compound). In the preparation of the semiconductive layers, the conductive filler may be added to the polymer in the molten state with full control of the production temperature. With this technology, a blend with sufficiently evolved dispersive and distributive mixing can be achieved by a person skilled in the art.

It is understood that the crosslinking agent is generally added to the semiconductive layer compositions in similar ways as for the insulation layer composition, as described in detail in the embodiments above.

It is preferred if all layers are crosslinked. The invention further provides therefore a crosslinked cable obtained by crosslinking cables defined herein.

The curing procedure can be carried out at increased temperature such as above 150° C., e.g. 160 to 350° C.

Melt mixing means mixing above the melting point of at least the major polymer component(s) of the obtained mixture and is typically carried out in a temperature of at least 10-15° C. above the melting or softening point of polymer component(s).

The term coextrusion means herein that all or part of the layer(s) are formed simultaneously using one or more extrusion heads. For instance a triple extrusion can be used for forming three layers.

In even further embodiments of the present invention, the insulation layer in the crosslinked cable of the invention has a DC conductivity of 80 fS/m or less; 70 fS/m or less; or, alternatively, 5 to 64 fS/m or less determined based on DC conductivity method at 70° C.

Moreover said first and second semiconductive compositions may, for example, be identical.

The thickness of the insulation layer of the power cable, for example, of the DC cable, e.g., of the HV DC or EHV DC power cable, is typically 2 mm or more, for example, at least 3 mm, e.g., of at least 5 to 100 mm, for example, from 5 to 50 mm, when measured from a cross section of the insulation layer of the cable.

The thickness of the inner and/or outer semiconductive layer of the power cable is typically 0.5 mm or more, for example, 0.7 mm to 5.0 mm when measured from a cross section of the layer.

Viewed from another aspect the invention provides a cable comprising a conductor which is surrounded by at least an inner semiconductive layer, an insulation layer and an outer semiconductive layer in that order;
wherein said inner and/or outer semiconductive layer comprises:
at least 50 wt-% of a LDPE homopolymer or LDPE copolymer,
0.005 to 2.5 wt-% of antioxidant(s),
25 to 48 wt-% carbon black; and
0.1 to 2.5 wt. % of a peroxide selected from the group consisting of a saturated aliphatic monofunctional peroxide and a saturated aliphatic bifunctional peroxide; and
wherein said insulation layer comprises
at least 80 wt-% of an LDPE homopolymer or LDPE copolymer; and
0.1 to 2.5 wt. % of a peroxide selected from the group consisting of an aliphatic monofunctional peroxide, an aliphatic bifunctional peroxide and a monofunctional peroxide containing an aromatic group.

Viewed from another aspect the invention provides a cable comprising a conductor which is surrounded by at least an inner semiconductive layer, an insulation layer and an outer semiconductive layer in that order;
wherein said inner and/or outer semiconductive layer comprises:
at least 55 wt-% of a LDPE homopolymer or LDPE copolymer,
0.1 to 1.5 wt-% of antioxidant(s),
25 to 41 wt-% carbon black; and
0.5 to 2.0 wt. % of a peroxide selected from the group consisting of a saturated aliphatic monofunctional peroxide and a saturated aliphatic bifunctional peroxide; and
wherein said insulation layer comprises
at least 95 wt-% of an LDPE homopolymer or LDPE copolymer; and
0.4 to 2.0 wt. % of a peroxide selected from the group consisting of an aliphatic monofunctional peroxide, an aliphatic bifunctional peroxide and a monofunctional peroxide containing an aromatic group.

The invention will now be described with reference to the following non-limiting examples.

### Determination Methods

Unless otherwise stated in the description or experimental part the following methods were used for the property determinations.
wt-%: % by weight

### Melt Flow Rate

The melt flow rate (MFR) is determined according to ISO 1133 and is indicated in g/10 min. The MFR is an indication of the flowability, and hence the processability, of the polymer. The higher the melt flow rate, the lower the viscosity of the polymer. The MFR is determined at 190° C. for polyethylenes and may be determined at different loadings such as 2.16 kg (MFR₂) or 21.6 kg (MFR₂₁).

### Density

The density was measured according to ISO 1183-1/method A. The sample preparation was executed according to ISO 1872-2 Table 3 Q (compression moulding).

### Preparation of Crosslinked Plaque for Hot Set

The crosslinked plaque is prepared from of pellets of the test semiconductive polymer composition, which was compression moulded using the following conditions: First the pellets are melted at 120° C. for 1 min under a pressure of 61 N/cm². Then the temperature is increased to 180° C. at a rate of 18 K/min and at the same time the pressure is increased to 614 N/cm². The temperature is maintained at 180° C. for 26 min. The plaques then become crosslinked by means of the peroxide present in the semiconductive polymer composition. After completed crosslinking the crosslinked plaque, i.e. here the crosslinked semiconductive polymer composition, is cooled to room temperature with a cooling rate of 15 K/min still under pressure. The thickness of the plaques is 1 mm.

### Hot Set

The hot set elongation as well as the permanent deformation were determined on samples taken from crosslinked plaques, i.e. the crosslinked semiconductive polymer composition according to the present invention and of the crosslinked comparative semiconductive polymer composition. These properties were determined according to IEC 60811-507:2012. In the hot set test, a dumbbell of the tested material is equipped with a weight corresponding to 20 N/cm² and marked with a reference length of 20 mm. This specimen is placed into an oven at 200° C. and after 15 minutes, the distance between the reference marks is measured and the hot set elongation is calculated. Subsequently, the weight is removed and the sample is allowed to relax for 5 minutes. Then, the sample is taken out from the oven and is cooled down to room temperature. The distance between the reference marks is measured and the permanent deformation is calculated.

The crosslinked plaques were prepared as described under Preparation of crosslinked plaque, and the dumbbells specimens are prepared from a 1 mm thick crosslinked plaque according to ISO 527-2/5A:2012

### DC Conductivity Method

Plaques were compression moulded from pellets of both insulation polymer composition and semiconductive polymer compositions separately, using press films of Teflon for both of the plaques. The insulation composition plaques, consisting of the polymer compositions to be tested, had a thickness of 1 mm and a diameter of 330 mm and the plaques, consisting of the semiconductive polymer composition, had a thickness of 0.3 mm and a diameter of 260 mm. The plaques consisting of the insulation polymer composition, and the plaques consisting of the semiconductive polymer compositions were prepared by press-moulding according to step 1 through 8 in the below table:

| Moulding step | 1 | 2 | 3 | 4 | 5 | 6 | 7 | 8 |
|---|---|---|---|---|---|---|---|---|
| Duration [s] | 180 | 160 | 60 | 500 | 240 | 1000 | 580 | 60 |
| Temperature [° C.] | 120 | 130 | 130 | 130 | 180 | 180 | 35 | 35 |
| Temperature ramp [° C./min] | 0 | 4 | 0 | 0 | 18 | 0 | 15 | 0 |
| Pressure [N/cm²] Semiconductive | 0 | 5.1 | 11.9 | 59.3 | 437.3 | 437.3 | 437.3 | 437.3 |
| Pressure [N/cm²] Insulation | 0 | 3.2 | 7.4 | 36.8 | 271.5 | 271.5 | 271.5 | 271.5 |

Directly after compression moulding a conditioning step was initiated, one plaque consisting of the crosslinked insulation polymer composition, and one plaque, consisting of the semiconductive polymer composition to be tested, were stored together in direct contact with each other in a closed aluminium bag at 70° C. for 24 hours. After the conditioning step the DC conductivity measurement was performed on the sandwich structure of the combined insulation and semiconductive plaque to be tested.

A high voltage source was connected to the upper electrode, to apply voltage over the test sample, i.e. the sandwich structure, consisting of the crosslinked polymer composition to be tested where the semiconductive plaque facing the high voltage electrode. The resulting current through the sample was measured with an electrometer/picoammeter. The measurement cell was a three electrodes system with brass electrodes placed in a heating oven. The diameter of the measurement electrode was 100 mm. Precautions were made to avoid flashovers from the round edges of the electrodes. The applied voltage was +30 kV DC meaning a mean electric field of 30 kV/mm and the temperature was as follows: 24 hours at 70° C., 10 hours at 30° C., 10 hours at 95° C. The current for the 70° C. value is recorded after 24 h, at the end of the 70° C. plateau, and the 95° C. value is recorded after 44 h, at the end of the 95° C. plateau, and these values were used to calculate the DC conductivity of the test sample at the two different temperatures, consisting of the crosslinked insulation polymer composition and semiconductive composition.

The conductivity σ is defined as the current density J divided by the applied electric field E. Then the relation between the measured current I through the sample and conductivity σ can be expressed in SI-units as

$$σ = \frac{J}{E} = \frac{I U}{a d} ( S / m )$$

I=Measured current
U=applied voltage
a=Area of the measuring electrode
d=Plaque thickness

### Experimental Part

The following materials were used in these examples:
EBA is an ethylene copolymer of butyl acrylate produced in a high pressure radical process. The MFR₂ is 18 g/10 min and the density is 924 kg/m³.
Carbon Black: Acetylene Black
Comparative Peroxide 1: 1,4-bis[2-(tert-butylperoxy)propan-2-yl]benzene and/or 1,3-bis[2-(tert-butylperoxy)propan-2-yl]benzene CAS 25155-25-3
Peroxide 2: 2,5-Dimethyl-2,5-di(tert-butylperoxy)hexane CAS 78-63-7
SRA1: 2,4-Diphenyl-4-methyl-1-pentene CAS 6362-80-7
Insulation layer was LS4258DCE commercially available from Borealis and contains peroxide of claim 1.

The semiconductive polymer composition is prepared in a co-kneader (BUSS, X-compounds) in which the conductive filler can be added to the polymer in the molten state with full control of the production temperature.

The crosslinking agent was added to the semiconductive polymer compositions after compounding.

The following precursor semiconductive compositions were prepared (all values in wt-%):

TABLE 1

| | Polymer composition 1 |
|---|---|
| EBA | 67.7 |
| Acetylene Black | 31.5 |
| AO (antioxidant) | 0.8 |

The precursor semiconductive compositions of table 1 are then used to prepare the following semiconductive compositions in tables 2 to 3:

TABLE 2

| | CE1 |
|---|---|
| Polymer composition 1 | 98.75 |
| Comparative Peroxide 1 | 1.25 |
| DC conductivity 70° C. | 84.5 |
| DC conductivity 95° C. | 441.1 |
| Hot set 20N/cm2 crosslinked plaques (%) | 6.70 |

TABLE 3

| | IE1 | IE2 | IE3 | IE4 | IE5 |
|---|---|---|---|---|---|
| Polymer composition 1 | 99.1 | 97.8 | 98.05 | 98.2 | 98.4 |
| Peroxide 2 | 0.9 | 2 | 1.75 | 1.5 | 1.5 |
| SRA1 (scorch retarder) | 0 | 0.2 | 0.2 | 0.3 | 0.1 |
| DC conductivity 70° C. | 48.3 | 54.5 | 54.3 | 61.0 | 55.7 |
| DC conductivity 95° C. | 273.2 | 309.9 | 313.9 | 329.2 | 313.1 |
| Hot set 20N/cm² crosslinked | 23.1 | 6.9 | 6 | 8.1 | 10.4 |
| plaques (%) | | | | | |

The data above demonstrates that semiconductive compositions of the invention with the defined peroxides, when in contact with insulation layer compositions as defined herein offer reduced DC conductivity in the insulation layer compared to the comparative examples. It is envisaged that the design of the semiconductive layers is such that fewer DC conductivity damaging species migrate from the semiconductive compositions of the invention into the insulation layer. Careful design therefore, of both semiconductive layers and the insulation layers offer improved cable performance.

1. A cable comprising:
a conductor which is surrounded by at least an inner semiconductive layer, an insulation layer, and an outer semiconductive layer in that order;
wherein said inner and/or outer semiconductive layer comprises:
an LDPE homopolymer or LDPE copolymer,
an antioxidant,
carbon black, and
a peroxide selected from the group consisting of a saturated aliphatic monofunctional peroxide and a saturated aliphatic bifunctional peroxide; and
wherein said insulation layer comprises:
an LDPE homopolymer or LDPE copolymer, and
a peroxide selected from the group consisting of an aliphatic monofunctional peroxide, an aliphatic bifunctional peroxide and a monofunctional peroxide containing an aromatic group.

2. The cable as claimed in claim 1, wherein the peroxide used in the inner and/or outer semiconductive layer is a liquid at a temperature of 20 to 45° C.

3. The cable as claimed in claim 1, wherein the peroxide used in the inner and/or outer semiconductive layer is 2,5-di(tert-butylperoxy)-2,5-dimethyl-hexane.

4. The cable as claimed in claim 1, wherein the inner semiconductive layer has the same chemical composition as the outer semiconductive layer.

5. The cable as claimed in claim 1, wherein the inner and/or outer semiconductive layer comprises an ethylene alkyl acrylate or ethylene vinyl acetate copolymer.

6. The cable as claimed in claim 5, wherein the inner and/or outer semiconductive layer comprises ethylene methyl acrylate, ethylene ethyl acrylate, or ethylene butyl acrylate.

7. The cable as claimed in claim 1, wherein the inner and/or outer semiconductive layer comprises 0.1 to 2.0 wt-% peroxide.

8. The cable as claimed in claim 1, wherein the insulation layer comprises an LDPE homopolymer or LDPE copolymer of ethylene and a polyunsaturated comonomer.

9. The cable as claimed in claim 1, wherein:
said inner and/or outer semiconductive layer comprises:
at least 50 wt-% of the LDPE homopolymer or LDPE copolymer;
0.005 to 2.5 wt-% of the antioxidant;
15 to 48 wt-% carbon black; and
0.1 to 2.5 wt. % of the peroxide; and
wherein said insulation layer comprises:
at least 80 wt-% of the LDPE homopolymer or LDPE copolymer; and
0.1 to 2.5 wt. % of the peroxide.

10. A crosslinked cable obtainable by the crosslinking of the cable of claim 1.

11. The crosslinked cable as claimed in claim 10, wherein the DC conductivity of the insulation layer is below 64 fS/m when measured according to the DC conductivity method at 70° C.

12. The crosslinked cable as claimed in claim 10, wherein the crosslinked cable is a direct current (DC) power cable.

13. A process for producing a cable comprising a conductor surrounded by at least an inner semiconductive layer, an insulation layer, and an outer semiconductive layer, in that order, wherein the process comprises the steps of:
extruding on the conductor, the inner semiconductive layer, the insulation layer, and the outer semiconductive layer; and
crosslinking one or more of said inner semiconductive layer, insulation layer, and outer semiconductive layer;
wherein said inner and outer semiconductive layer independently comprises an LDPE homopolymer or LDPE copolymer, antioxidant, carbon black and a peroxide selected from the group consisting of a saturated aliphatic monofunctional peroxide and a saturated aliphatic bifunctional peroxide;
wherein said insulation layer comprises an LDPE homopolymer or LDPE copolymer and a peroxide selected from the group consisting of an aliphatic monofunctional peroxide, an aliphatic bifunctional peroxide and a monofunctional peroxide containing an aromatic group.

14. The process as claimed in claim 13, further comprising crosslinking at least the semiconductive layer and the insulation layer.

15. The process as claimed in claim 14, wherein the process comprises exposing the cable to heat to thereby crosslink at least the semiconductive layer and the insulation layer.

16. The cable as claimed in claim 1, wherein the peroxide used in the inner and/or outer semiconductive layer is a liquid at a temperature of 25 to 40° C.
